(19) United States
(12) Patent Application Publication
(10) Pub. No.: US 2025/0285099 A1
(43) Pub. Date: Sep. 11, 2025

(54) INFORMATION PROCESSING DEVICE, INFORMATION PROCESSING SYSTEM, AND INFORMATION PROCESSING METHOD

(71) Applicant: TOSHIBA TEC KABUSHIKI KAISHA, Tokyo (JP)

(72) Inventors: Hideyuki Wada, Ota Tokyo (JP); Yuki Kawasaki, Numazu Shizuoka (JP); Mayuko Tsunoda, Yokohama Kanagawa (JP); Kengo Fukushima, Ota Tokyo (JP); Shigeru Sato, Yokohama Kanagawa (JP)

(21) Appl. No.: 19/015,734

(22) Filed: Jan. 10, 2025

(30) Foreign Application Priority Data
Mar. 8, 2024 (JP) 2024-035800

(51) Int. Cl. G06Q 20/32; G06Q 30/0601

(52) U.S. Cl. CPC G06Q 20/3224; G06Q 30/0639

(57) ABSTRACT

An information processing device in an embodiment includes a brought-in commodity grasping unit configured to grasp, based on commodity specifying information of brought-in commodities brought into a fitting room, the brought-in commodities, a purchase commodity grasping unit configured to grasp, based on commodity specifying information of, among the brought-in commodities, purchase commodities subjected to commodity purchasing processing in a purchase processing device installed in the fitting room, the purchase commodities, a determination unit configured to determine, from the brought-in commodities and the purchase commodities, nonpurchase commodities not to be purchased, and a display transmission unit configured to transmit, to a display provided near the fitting room, display information for causing the display to display the purchase commodities and the nonpurchase commodities to be discriminable.

### CROSS-REFERENCE TO RELATED APPLICATION

This application is based upon and claims the benefit of priority from Japanese Patent Application No. 2024-035800, filed on Mar. 8, 2024, the entire contents of which are incorporated herein by reference.

### FIELD

Embodiments described herein relate generally to an information processing device, an information processing system, and an information processing method.

### BACKGROUND

In recent years, in an apparel store (hereinafter referred to as “store”) that sells clothing and the like, a customer brings a plurality of commodities into a fitting room and tries the commodities on and determines commodities to be purchased and commodities not to be purchased. If performing settlement for the commodities, a store clerk sometimes has difficulty in determining the commodities to be purchased and the commodities not to be purchased. If the customer himself or herself performs settlement for the commodities in the fitting room as expected in future, the store clerk is likely to have difficulty in distinguishing settled commodities (the commodities to be purchased) and unsettled commodities (the commodities not to be purchased).

### BRIEF DESCRIPTION OF THE DRAWINGS

FIG. 1 is an explanatory diagram illustrating a layout of an apparel store and movements of a customer;

FIG. 2 is an explanatory diagram illustrating another layout of the apparel store and movements of a customer;

FIG. 3 is a system diagram illustrating a system;

FIG. 4 is a block diagram illustrating hardware components of a digital mirror;

FIG. 5 is a diagram illustrating a display example of the digital mirror;

FIG. 6 is a diagram illustrating another display example of the digital mirror;

FIG. 7 is a diagram illustrating still another display example of the digital mirror;

FIG. 8 is a block diagram illustrating hardware components of a server

FIG. 9 is a memory map illustrating a memory configuration of a customer master;

FIG. 10 is a memory map illustrating a memory configuration of a customer file;

FIG. 11 is a memory map illustrating a memory configuration of a fitting room information section;

FIG. 12 is a block diagram illustrating hardware components of a gate;

FIG. 13 is a block diagram illustrating hardware components of a checkout machine;

FIG. 14 is a block diagram illustrating hardware components of a display;

FIG. 15 is a sequence chart illustrating a flow of main processing among the digital mirror, the server, the gate, the checkout machine, and the display;

FIG. 16 is a functional block diagram illustrating functional components of an information processing system;

FIG. 17 is a flowchart illustrating control processing for the digital mirror;

FIG. 18 is a flowchart illustrating control processing for the server;

FIG. 19 is a flowchart illustrating control processing for the gate;

FIG. 20 is a flowchart illustrating control processing for the checkout machine;

FIG. 21 is a flowchart illustrating control processing for the display; and

FIG. 22 is a diagram illustrating a display example of the display.

### DETAILED DESCRIPTION

An aspect of embodiments is to provide a server, a system, and a method with which a store clerk is capable of easily determining distinction of commodities to be purchased and commodities not to be purchased.

An information processing device in an embodiment includes: a brought-in commodity grasping unit configured to grasp, based on commodity specifying information of brought-in commodities brought into a fitting room, the brought-in commodities; a purchase commodity grasping unit configured to grasp, based on commodity specifying information of, among the brought-in commodities, purchase commodities subjected to commodity purchasing processing in a purchase processing device installed in the fitting room, the purchase commodities; a determination unit configured to determine, from the brought-in commodities and the purchase commodities, nonpurchase commodities not to be purchased; and a display transmission unit configured to transmit, to a display provided near the fitting room, display information for causing the display to display the purchase commodities and the nonpurchase commodities to be discriminable.

An embodiment is explained below with reference to the drawings. In the embodiment, a server is explained as an example of an information processing device. A checkout machine is explained as an example of a purchase processing device. In the embodiment, the information processing device, a gate, and the purchase processing device configure an information processing system. Note that the embodiment explained below is not limiting.

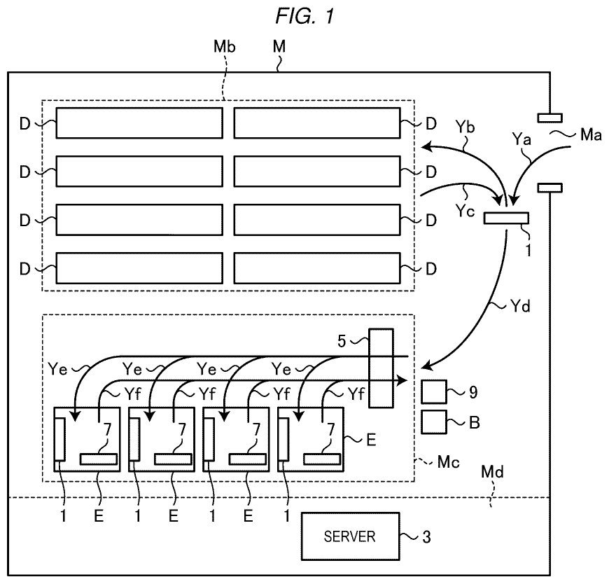

FIG. 1 is a diagram illustrating store interior arrangement of an apparel store according to the embodiment. The apparel store is a store that sells clothing (commodities) (the apparel store is hereinafter simply referred to as “store” as well). A customer brings commodities displayed in the store into a fitting room (the commodities brought into the fitting room are referred to as brought-in commodities) and purchases a favorite commodity, a commodity, a size of which fits the customer, and the like. In the embodiment, the customer performs, in the fitting room, commodity registration and settlement for commodities to be purchased (the commodities for which the commodity registration and the settlement were performed is referred to as purchase commodities). A store clerk distinguishes the purchase commodities purchased by the customer and commodities not to be purchased (the commodities not to be purchased is referred to as nonpurchase commodities) from the commodities carried by the customer who exited the fitting room.

In FIG. 1, a store M includes a doorway Ma, a commodity display area Mb, a fitting area Mc, and a back office Md. A customer enters and exits the store M through the doorway Ma. A digital mirror 1 is provided near the doorway Ma in the store M. A gate 5 is installed near a doorway of the fitting area Mc. A server 3 (an information processing device) is installed in the back office Md.

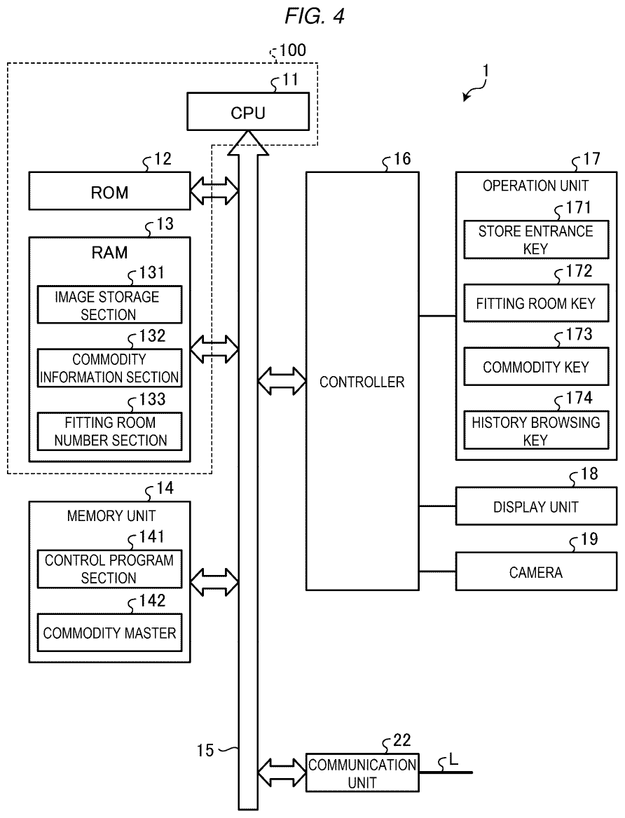

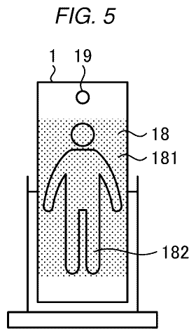

The digital mirror 1 includes a half mirror (not illustrated), a display unit 18 (see FIG. 4), and a camera 19 (see FIG. 4). In a state in which the display unit 18 displays nothing, the digital mirror 1 functions as a mirror that reflects the figure of the customer. In a state in which the display unit 18 displays something, the digital mirror 1 functions as a display. The display unit 18 is provided on the rear side (a side opposite to a position where the customer stands) of the half mirror and displays information to the customer standing in front of the digital mirror 1. The camera 19 images the face of the customer standing in front of the digital mirror 1. Note that the functions and the display of the digital mirror 1 are explained below with reference to FIGS. 5 to 7.

A plurality of shelves D are installed in the commodity display area Mb. Various commodities are displayed on the plurality of shelves D. Wireless tags (not illustrated) such as RFID tags are attached to all the commodities displayed on the shelves D. Individual commodity codes (commodity specifying information) for uniquely specifying the commodities to which the wireless tags are attached are stored in the wireless tags. The wireless tags transmit tag information including the individual commodity codes. Note that the individual commodity codes include commodity codes for specifying types of the commodities.

In the fitting area Mc, a plurality of (in the embodiment, four) fitting rooms E are installed. The fitting rooms E are private rooms into which customers bring commodities to try the commodities on. The gate 5 is provided at the doorway of the fitting area Mc. A store clerk who collects commodities not to be purchased is stationed near the gate 5. A display 9 is provided near the store clerk.

Purchase commodities to be purchased by a customer and nonpurchase commodities not to be purchased by the customer are displayed on the display 9. The store clerk views the display of the display 9 and grasps the nonpurchase commodities to be collected. Note that the display 9 is an information terminal such as a node PC (Personal Computer) or a tablet terminal. However, the display 9 may be a wearable terminal that the store clerk can wear on an arm or a portable terminal that the store clerk can carry.

Checkout machines 7 are installed in the fitting rooms E. The checkout machines 7 are devices with which customers perform commodity registration and settlement for commodities to be purchased. In the fitting rooms E, the same digital mirrors 1 as the digital mirror 1 installed near the doorway Ma are provided.

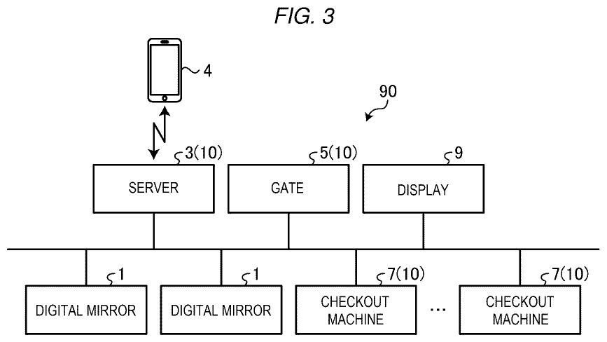

A customer visiting the store M enters the store M from the doorway Ma and stands in front of the digital mirror 1 installed near the doorway Ma (an arrow Ya). Then, the camera 19 images the face of the customer. A captured face image is compared with a face image registered in the server 3 in advance and entrance registration for specifying the customer is performed. Subsequently, the customer moves to the commodity display area Mb (an arrow Yb) and takes, from the shelves D, commodities to be tried on. Subsequently, the customer moves to the digital mirror 1 (an arrow Yc) and operates the digital mirror 1 to search for a vacant fitting room E. The digital mirror 1 displays a number of the vacant fitting room E. The number of the vacant fitting room E is also displayed on a portable terminal 4 (see FIG. 3) carried by the customer. Subsequently, the customer goes to the fitting area Mc (an arrow Yd) and passes through the gate 5 while carrying the commodities. Then, the gate 5 receives tag information transmitted by wireless tags attached to the brought-in commodities (the commodities having passed through the gate 5 are also referred to as brought-in commodities) and grasps the brought-in commodities from individual commodity codes included in the tag information.

The customer having passed through the gate 5 goes to a designated fitting room E (an arrow Ye) and enters the fitting room E. The customer tries the brought-in commodities on in the fitting room E. At that time, the customer can reflect the figure of the customer on the digital mirror 1 installed in the fitting room E. The customer determines commodities to be purchased and commodities not to be purchased as a result of the try-on. Then, the customer brings wireless tags close to the checkout machine 7 for a commodity to be purchased and executes commodity registration for the commodity. If commodity registration for all the commodities to be purchased ends, the customer operates the checkout machine 7 to perform settlement for the commodities to be purchased. The customer, who finished the settlement, exits the fitting room E carrying all the brought-in commodities and goes to the gate 5 (an arrow Yf). Then, the customer passes through the gate 5. At this time, the server 3 grasps the commodities settled by the customer (the purchase commodities) and the commodities not settled by the customer (the nonpurchase commodities). The display 9 divides and displays the purchase commodities and the nonpurchase commodities based on information received from the server 3. The store clerk views display of the display 9, collects the nonpurchase commodities, and puts the nonpurchase commodities in a collection box B.

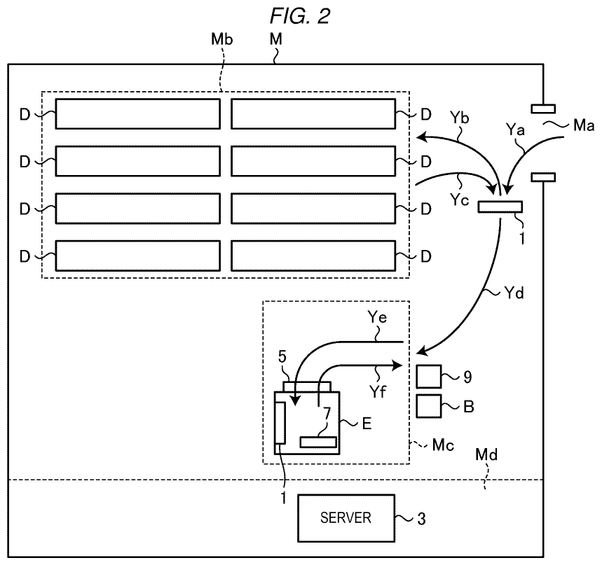

FIG. 2 is a diagram illustrating store interior arrangement of the store M including one fitting room E. In this case, the gate 5 is installed at a doorway of the fitting room E. The other arrangement is the same as the arrangement illustrated in FIG. 1. In the case of FIG. 2, a customer passes through the gate 5 if entering the fitting room E and if exiting the fitting room E.

Subsequently, the devices installed in the store M are explained. FIG. 3 is a system diagram illustrating a system 90 including the server 3 and an information processing system 10. As illustrated in FIG. 3, the system 90 includes the digital mirrors 1, the server 3, the gate 5, the checkout machines 7, and the display 9. The information processing system 10 includes the server 3, the gate 5, and the checkout machines 7. The digital mirrors 1, the server 3, the gate 5, the checkout machines 7, and the display 9 are communicably connected to one another by a communication line L such as a LAN (Local Area Network). The portable terminal 4 carried by a customer is communicably connected to the server 3 by a network NW such as the Internet.

The surface of the digital mirror 1 is configured by a half mirror and has a function of a looking glass for a customer located in the front of the digital mirror 1. The digital mirror 1 includes the display unit 18 on the rear surface of the half mirror. The customer located in the front can view display of the display unit 18 via the half mirror. The digital mirror 1 includes the camera 19. The camera 19 images, via the half mirror, the face of the customer located in the front. Note that the camera 19 may be provided in an upper part of the digital mirror 1 (on the outside of the half mirror). In the embodiment, the digital mirrors 1 are provided near the doorway Ma and in the fitting rooms E. However, the digital mirrors 1 may be installed near doorways of the commodity display area Mb and the fitting area Mc.

The digital mirror 1 displays a vacant fitting room E based on operation of the customer. Specifically, the digital mirror 1 displays a fitting room number of the vacant fitting room E.

The server 3 manages sales data of commodities in the store M. The server 3 manages a customer who entered the store M. Specifically, the server 3 captures, with the camera 19 of the digital mirror 1 near the doorway Ma, a face image of the customer who entered the store M, analyzes the face image to calculate a feature value, compares the feature value with a feature value of the customer store in advance to specify the customer, and creates a customer file 332 (see FIG. 10) of the customer who entered the store M.

The server 3 always grasps a vacant fitting room E and notifies the customer of information concerning the fitting room E that the customer enters. Specifically, the server 3 transmits fitting room information indicating a fitting room number of the vacant fitting room E to the digital mirror 1. The digital mirror 1 displays the fitting room number based on the received fitting room information. The server 3 transmits the fitting room number to the portable terminal 4 carried by the customer. The portable terminal 4 displays the fitting room number received from the server 3. The customer views the fitting room number displayed on the digital mirror 1 or the portable terminal 4 and recognizes the fitting room E that the customer uses.

The server 3 grasps, based on individual commodity codes (brought-in commodity information) that is commodity specifying information received from the gate 5, commodities that the customer brought into the fitting room E. The server 3 grasps, based on individual commodity codes (commodity specifying information) included in commodity information and settlement information received from the checkout machine 7, purchase commodities settled by the checkout machine 7. Individual commodity codes for specifying the purchase commodities are purchase commodity information.

The server 3 determines, based on brought-in commodity information of purchase commodities brought into the fitting room E and purchase commodity information of purchase commodities settled by the checkout machine 7, nonpurchase commodity among brought-in commodities. The server 3 transmits display information for dividing and displaying, on the display 9, purchase commodities purchased by the customer and nonpurchase commodities to the display 9.

The gate 5 receives tag information transmitted from wireless tags attached to brought-in commodities brought in by a customer who enters the fitting area Mc in FIG. 1 (the fitting room E in FIG. 2). The gate 5 acquires individual commodity codes included in the received tag information and transmits room entrance information including the individual commodity codes (brought-in commodity information) to the server 3. The gate 5 receives tag information transmitted from wireless tags attached to brought-in commodities carried by the customer who exits the fitting area Mc or the fitting room E. The gate 5 acquires individual commodity codes included in the received tag information and transmits room exit information including the individual commodity codes to the server 3. Note that the gate 5 includes a room entrance and exit sensor 60 (see FIG. 12) and is capable of determining, with an output from the sensor, whether the customer passed through the gate 5 and entered the fitting area Mc (or the fitting room E) or passed through the gate 5 and exited the fitting area Mc (or the fitting room E). If determining that the customer entered the fitting area Mc (or the fitting room E), the gate 5 transmits, to the server 3, information indicating that the customer entered the fitting room E and room entrance information including the individual commodity codes. If determining that the customer exited the fitting area Mc (or the fitting room E), the gate 5 transmits, to the server 3, information indicating that the customer exited the fitting room E and room exit information including the individual commodity codes.

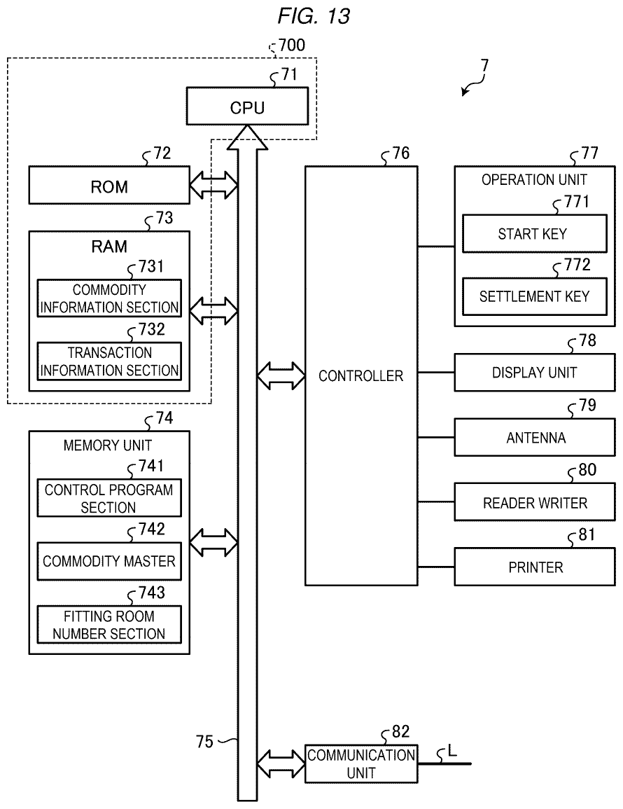

The checkout machines 7 are provided in the fitting rooms E. If a wireless tag is held over an antenna 79 (see FIG. 13), the checkout machine 7 executes commodity registration processing (an example of commodity purchase processing) for a commodity to which the wireless tag is attached. The commodity registration processing means processing for reading commodity information (a commodity name, a commodity price, and the like) of the commodity from a commodity master 742 (see FIG. 13), displaying the commodity information on a display unit 78 (see FIG. 13), and storing the commodity information in a commodity information section 731 (see FIG. 13). The checkout machine 7 executes settlement processing (an example of commodity purchase processing) for commodities subjected to the commodity registration processing. The settlement processing means processing for displaying, on the display unit 78, a total amount for the commodities stored in the commodity information section 731 and performing money processing (in the embodiment, money processing by noncash) relating to this transaction based on a used medium. The settlement processing includes processing for storing, in a transaction information section 732 (see FIG. 13), commodity information and settlement information (the total amount, the medium used for the settlement, and the like) of the commodities subjected to the money processing.

The checkout machine 7 transmits, to the server 3, the commodity information and the settlement information (including individual commodity codes of the settled commodities) relating to the commodities subjected to the settlement processing.

The display 9 is, for example, a personal computer, a tablet terminal, a portable terminal, or a wearable terminal. The display 9 receives display information from the server 3 and divides and displays information concerning purchase commodities and nonpurchase commodities.

Subsequently, hardware components of the digital mirror 1 are explained. FIG. 4 is a block diagram illustrating the hardware components of the digital mirror 1. As illustrated in FIG. 4, the digital mirror 1 includes a CPU (Central Processing Unit) 11, which is an example of a processor, a ROM (Read Only Memory) 12, a RAM (Random Access Memory) 13, and a memory unit 14. The CPU 11 serves as a control entity. The ROM 12 stores various programs. Various data are loaded in the RAM 13. The memory unit 14 stores various programs. The CPU 11, the ROM 12, the RAM 13, and the memory unit 14 are connected to one another via a data bus 15. The CPU 11, the ROM 12, and the RAM 13 configure a control unit 100. That is, the CPU 11 operates according to a control program stored in the ROM 12 or the memory unit 14 and loaded in the RAM 13, whereby the control unit 100 executes control processing for the digital mirror 1 explained below.

The RAM 13 includes an image storage section 131, a commodity information section 132, and a fitting room number section 133. The image storage section 131 stores a face image of a customer captured by the camera 19. The commodity information section 132 stores commodity information of a commodity sold in the store M, the commodity information being searched and extracted by operation of the customer. The fitting room number section 133 stores fitting room information indicating a fitting room number of a vacant fitting room E, the fitting room information being received from the server 3.

The memory unit 14 is configured by a nonvolatile memory such as a HDD (Hard Disc Drive) or a flash memory in which stored information is retained even if power is turned off. The memory unit 14 includes a control program section 141 that stores the control program. The memory unit 14 includes a commodity master 142. The commodity master 142 stores, for each commodity specifying information for specifying a commodity (each commodity code for specifying a type of the commodity), commodity information such as a commodity name, a price (a unit price), and an attribute of the commodity.

The control unit 100 is connected to the operation unit 17, the display unit 18, and the camera 19 via the data bus 15 and a controller 16.

The operation unit 17 is a touch panel provided on the display unit 18. The operation unit 17 includes a store entrance key 171, a fitting room key 172, a commodity key 173, and a history browsing key 174. A customer operates the store entrance key 171 if the customer enters the store M from the doorway Ma. If the store entrance key 171 is operated, the control unit 100 drives the camera 19 to image the face of the customer and transmits a captured face image to the server 3. The customer operates the fitting room key 172 if the customer desires to try a commodity on and searches for a vacant fitting room E. If the fitting room key 172 is operated, the control unit 100 inquires the server 3 about a vacant fitting room E. If receiving vacant fitting room information from the server 3, the control unit 100 displays a fitting room number indicated by the vacant fitting room information on the display unit 18.

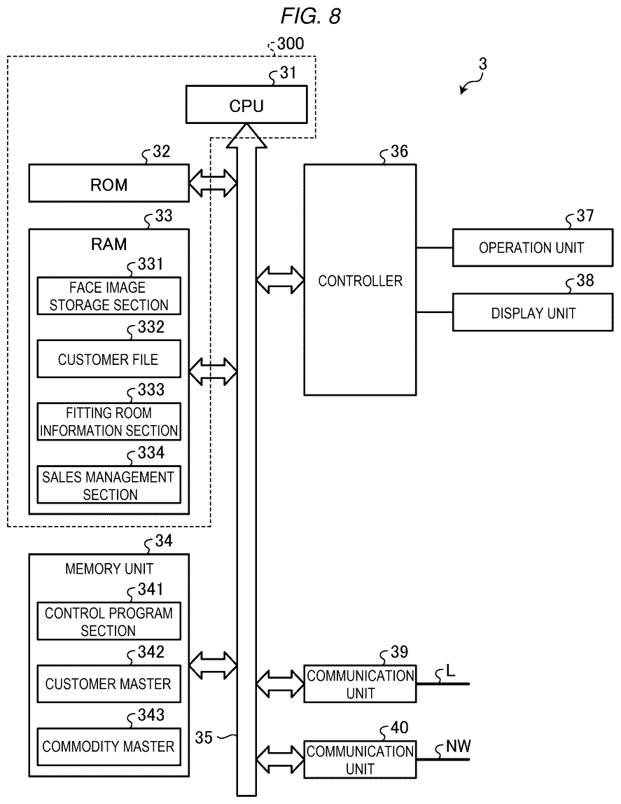

The customer operates the commodity key 173 if the customer searches for a desired commodity. For example, if the customer failed in finding the desired commodity in the store M (the commodity display area Mb), the customer operates the commodity key 173 and causes the server 3 to search for the desired commodity. The server 3 extracts commodities as a result of the search. The control unit 100 receives commodity information of the commodities extracted by the server 3 and stores the commodity information in the commodity information section 132. The control unit 100 displays the extracted commodities on the display unit 18. If the desired commodity is present among the displayed commodities, the customer designates (selects) the commodity. Then, the control unit 100 notifies information concerning the designated commodity to a store clerk. The store clerk receives the notification and hands the designated commodity over to the customer. The customer operates the history browsing key 174 if the customer invokes a commodity purchased in the past by the customer or a commodity searched or a commodity designated in the past by operating the commodity key 173. By operating the history browsing key 174, the customer can invoke a past history from a customer master 342 (see FIG. 8) and browse the past history. The display unit 18 is, for example, a liquid crystal display and displays information to the customer. The camera 19 images the face of the customer.

The control unit 100 is connected to the communication unit 22 via the data bus 15. The communication unit 22 is connected to the server 3, the gate 5, the checkout machines 7, and the display 9 via a communication line L to be capable of transmitting and receiving information and data.

Here, functions of the digital mirror 1 are explained. FIG. 5 is a diagram illustrating the digital mirror 1 in a state in which the display unit 18 displays nothing. In this case, a FIG. 182 of a customer located in the front of the digital mirror 1 is reflected on a half mirror 181 of the digital mirror 1 (the digital mirror 1 functions as a looking glass (a mirror)). Note that, although not illustrated, in the state illustrated in FIG. 5, the display unit 18 displays images of the store entrance key 171, the fitting room key 172, the commodity key 173, and the history browsing key 174 in a part (a position not hindering the looking glass) of the digital mirror 1.

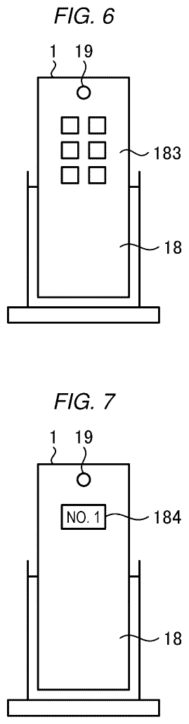

If the commodity key 173 and the history browsing key 174 are operated, as illustrated in FIG. 6, commodity images 183 of commodities extracted as a result of the search or the commodity images 183 of commodities browsed in the past are displayed on the display unit 18. The customer touches an image of a desired commodity out of the displayed commodity images 183, whereby the commodity is designated.

If the fitting room key 172 is operated, as illustrated in FIG. 7, a fitting room number 184 indicating a vacant fitting room E received from the server 3 is displayed on the display unit 18. The customer checks the displayed vacant fitting room number 184 and goes to the designated fitting room E.

Note that the functions of the digital mirror 1 illustrated in FIGS. 5 to 7 can be the same not only in the digital mirror 1 installed near the doorway Ma but also the other digital mirrors 1 installed in the store M and the fitting rooms E.

FIG. 8 is a block diagram illustrating hardware components of the server 3. As illustrated in FIG. 8, the server 3 includes a CPU 31, which is an example of a processor, a ROM 32, a RAM 33, and a memory unit 34. The CPU 31 serves as a control entity. The ROM 32 stores various programs. Various data are loaded in the RAM 33. The memory unit 34 stores various programs. The CPU 31, the ROM 32, the RAM 33, and the memory unit 34 are connected to one another via a data bus 35. The CPU 31, the ROM 32, and the RAM 33 configure a control unit 300. The CPU 31 operates according to a control program stored in the ROM 32 or the memory unit 34 and loaded in the RAM 33, whereby the control unit 300 executes control processing for the server 3 explained below.

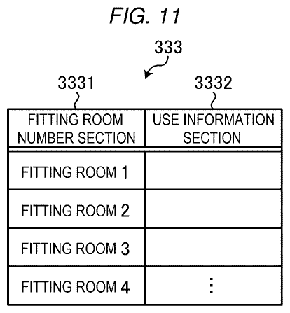

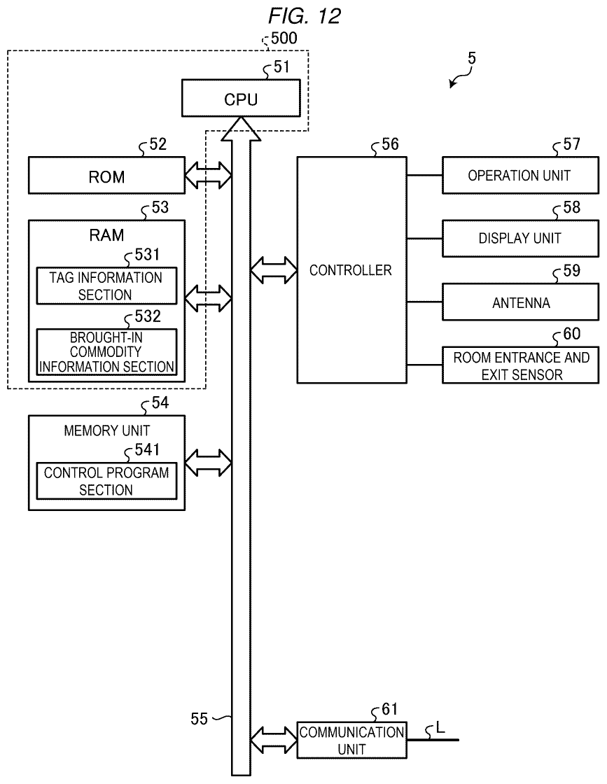

The RAM 33 includes a face image storage section 331, a customer file 332, a fitting room information section 333, and a sales management section 334. The face image storage section 331 stores information concerning a face image captured by the camera 19, the information being received from the digital mirror 1. The customer file 332 reads, from a customer master 342, various kinds of information concerning a customer specified based on the face image stored by the face image storage section 331 and stores the information. The customer file 332 is explained below with reference to FIG. 10. The fitting room information section 333 manages, for each fitting room E, in real time, use situations of the fitting rooms E installed in the fitting area Mc. For example, not-illustrated human sensors are provided in the fitting rooms E. A flag “1”, which is information indicating presence (for example, flag information indicating presence), is stored for the fitting room E in which the human sensor detects a person. A flag “0”, which is information indicating absence (for example, flag information indicating absence), is stored for the fitting room E in which the human sensor does not detect a person. The fitting room information section 333 is explained below with reference to FIG. 11. The sales management section 334 stores, based on commodity information and settlement information received from the checkout machines 7, sales of the store M obtained by accumulating sales data of settled commodities and manages the sales.

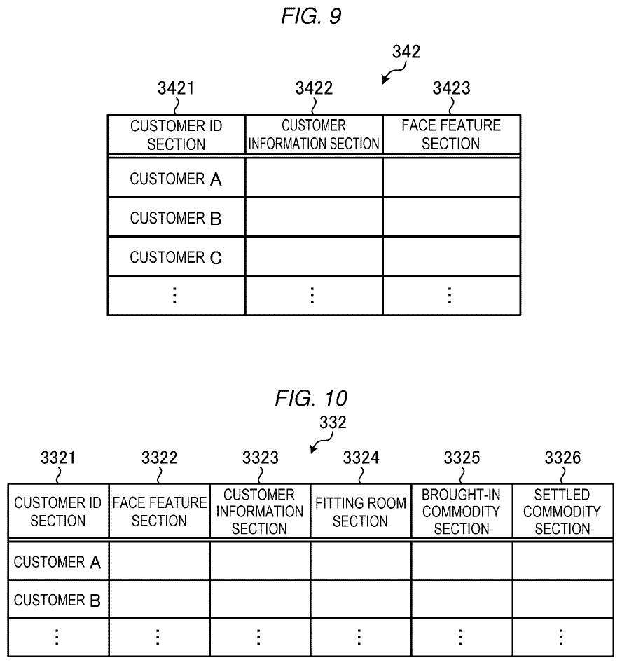

The memory unit 34 is configured by a nonvolatile memory such as a HDD or a flash memory in which stored information is retained even if power is turned off. The memory unit 34 includes a control program section 341 that stores the control program, a customer master 342, and a commodity master 343. The customer master 342 stores, for each customer, customer information of a customer registered as a member (a name, an address, a telephone number, a mail address of a portable terminal (for example, the portable terminal 4), a size of a commodity (clothing) suitable for the customer, a purchase history and a browsing history of commodities in the past, and the like). The customer master 342 is explained below with reference to FIG. 9. The commodity master 343 stores commodity information of a commodity sold in the store M (a commodity code for specifying a type of the commodity, a commodity name, a price of the commodity, attribute information (a color and a size) of the commodity, and the like).

The control unit 300 is connected to an operation unit 37 and a display unit 38 via the data bus 35 and a controller 36. The operation unit 37 is a keyboard for operating the server 3. The display unit 38 displays information to an operator who operates the server 3.

The control unit 300 is connected to a communication unit 39 via the data bus 35. The communication unit 39 is connected to the digital mirrors 1, the gate 5, the checkout machines 7, and the display 9 via the communication line L to be capable of transmitting and receiving information and data. The control unit 300 is connected to a communication unit 40 via the data bus 35. The communication unit 40 is connected to the portable terminal 4 via the network NW to be capable of transmitting and receiving information and data.

Subsequently, the customer master 342 is explained. FIG. 9 is a memory map illustrating a memory configuration of the customer master 342. The customer master 342 includes a customer ID section 3421, a customer information section 3422, and a face feature section 3423. The customer ID section 3421 stores, for each customer, a customer ID (Identification) for specifying the customer. The customer master 342 stores customer information of the customer in association with the customer ID stored in the customer ID section 3421. The face feature section 3423 stores a feature value indicating a feature of the face of the customer in association with the customer ID stored in the customer ID section 3421. The feature value of the face is, for example, vector information indicating each of features of parts (an eye, a nose, a mouth, an ear, a chin, a contour of a face, and the like) of the face calculated using a publicly-known general object recognition technology based on a captured face image.

The general object recognition technology is described in, for example, ‘Keiji Yanai, “Present Situation and Future of General Object Recognition”, Journal of Information Processing Society, Vol. 38, No. SIG16 [searched on Aug. 10, 2010], Internet <URL: http://mm.cs.uec.ac.jp/IPSJ-TCVIM-Yanai.pdf>”.

Subsequently, the customer file 332 is explained. FIG. 10 is a memory map illustrating a memory configuration of the customer file 332. If the face of a customer is imaged by the camera 19 in the digital mirror 1 installed near the doorway Ma of the store M (or another digital mirror 1), feature values of parts of the face calculated based on a captured face image and feature values stored in the face feature section 3423 of the customer master 342 are compared, a customer ID stored in the customer ID section 3421 storing a feature value having the highest similarity is determined, and the customer file 332 relating to a customer having the customer ID is created. Customer files 332 are respectively created for customers imaged by the camera 19. Note that, if the face of a customer for whom the customer file 332 was once created is imaged again, since the customer file 332 of the customer was already created, the customer file 332 is not created again while the customer is present in the store M.

As illustrated in FIG. 10, the customer file 332 includes a customer ID section 3321, a face feature section 3322, a customer information section 3323, a fitting room section 3324, a brought-in commodity section 3325, and a settled commodity section 3326. The customer ID section 3321 stores, for each customer, a customer ID for specifying the customer. The face feature section 3322 stores a feature value indicating a feature of the face of the customer stored in the face feature section 3423 in association with the same customer ID (the customer ID stored in the customer ID section 3421) as the customer ID stored in the customer ID section 3321. The customer information section 3323 stores customer information of the customer stored in the customer information section 3422 in association with the same customer ID (the customer ID stored in the customer ID section 3421) as the customer ID stored in the customer ID section 3321.

The fitting room section 3324 stores fitting room information indicating a fitting room number of the fitting room E used by the customer having the customer ID stored in the customer ID section 3321. If the customer operates the fitting room key 172 displayed on the digital mirror 1, the control unit 100 inquires the server 3 about vacancy information of the fitting rooms E and receives fitting room information of a vacant fitting room E. On the other hand, the camera 19 images the face of the customer and compares a feature value to determine one customer ID. The control unit 100 stores the received fitting room information in the customer file 332 created with the determined customer ID (specifically, the fitting room section 3324 associated with the determined customer ID).

The brought-in commodity section 3325 stores brought-in commodity information relating to commodities brought into the fitting room E by the customer specified by the customer ID stored in the customer ID section 3321. Specifically, the brought-in commodity section 3325 stores an individual commodity code for uniquely specifying a brought-in commodity included in tag information transmitted from a wireless tag attached to the brought-in commodity brought into the fitting room E, the tag information being received by an antenna 59 (see FIG. 12) of the gate 5 if the customer passed through the gate 5 in order to enter the fitting room E after the fitting room number was displayed on the display unit 18.

The settled commodity section 3326 stores purchase commodity information of a commodity subjected to settlement processing by the checkout machine 7. Specifically, if transmitting commodity information and settlement information to the server 3, the checkout machine 7 adds, to the commodity information and the settlement information, fitting room information indicating a fitting room number of the fitting room E in which the checkout machine 7 is installed and transmits the fitting room information. The server 3 stores, based on the fitting room information received simultaneously with the commodity information and the settlement information received from the checkout machine 7, purchase commodity information (an individual commodity code) based on the received commodity information and the received settlement information in the settled commodity section 3326 associated with the received fitting room information stored in the fitting room section 3324.

Subsequently, the fitting room information section 333 is explained. FIG. 11 is a memory map illustrating a memory configuration of the fitting room information section 333. As illustrated in FIG. 11, the fitting room information section 333 includes a fitting room number section 3331 and a use information section 3332. The fitting room number section 3331 stores a fitting room number for specifying the fitting room E. The use information section 3332 stores, in association with the fitting room number stored in the fitting room number section 3331, information indicating a use situation of the fitting room E (whether the fitting room E is used or not used) (for example, flag information in which a flag “1” indicates that the fitting room E is used and a flag “0” indicates that the fitting room E is not used).

Hardware of the gate 5 is explained below. FIG. 12 is a block diagram illustrating hardware components of the gate 5. As illustrated in FIG. 12, the gate 5 includes a CPU 51 that is an example of a processor, a ROM 52, a RAM 53, and a memory unit 54. The CPU 51 serves as a control entity. The ROM 52 stores various programs. Various data are loaded in the RAM 53. The memory unit 54 stores various programs. The CPU 51, the ROM 52, the RAM 53, and the memory unit 54 are connected to one another via a data bus 55. The CPU 51, the ROM 52, and the RAM 53 configure a control unit 500. That is, the CPU 51 operates according to a control program stored in the ROM 52 or the memory unit 54 and loaded in the RAM 53, whereby the control unit 500 executes control processing for the gate 5 explained below.

The RAM 53 includes a tag information section 531 and a brought-in commodity information section 532. The tag information section 531 stores tag information received by the antenna 59. The brought-in commodity information section 532 stores an individual commodity code (brought-in commodity information) included in the tag information stored by the tag information section 531.

The memory unit 54 is configured by a nonvolatile memory such as a HDD or a flash memory in which stored information is retained even if power is turned off. The memory unit 54 includes a control program section 541 that stores the control program.

The control unit 500 is connected to an operation unit 57, a display unit 58, the antenna 59, and the room entrance and exit sensor 60 via the data bus 55 and a controller 56. The operation unit 57 is a keyboard for operating the gate 5. The display unit 58 displays information to an operator who operates the gate 5. The antenna 59 receives tag information including an individual commodity code transmitted from a wireless tag attached to a commodity that passes through the gate 5. The room entrance and exit sensor 60 is a sensor that detects whether a customer passes through the gate 5 and enters the fitting area Mc or passes through the gate 5 and exits the fitting area Mc. For example, the room entrance and exit sensor 60 is a sensor capable of detecting a passing direction of the customer passing through the gate 5. The room entrance and exit sensor 60 detects, based on the passing direction, whether the customer enters the fitting area Mc or exits the fitting area Mc.

The control unit 500 is connected to a communication unit 61 via the data bus 55. The communication unit 61 is connected to the digital mirrors 1, the server 3, the checkout machines 7, and the display 9 via the communication line L to be capable of transmitting and receiving information and data.

Subsequently, hardware of the checkout machine 7 is explained. FIG. 13 is a block diagram illustrating hardware components of the checkout machine 7. As illustrated in FIG. 13, the checkout machine 7 includes a CPU 71 that is an example of a processor, a ROM 72, a RAM 73, and a memory unit 74. The CPU 71 serves as a control entity. The ROM 72 stores various programs. Various data are loaded in the RAM 73. The memory unit 74 stores various programs. The CPU 71, the ROM 72, the RAM 73, and the memory unit 74 are connected to one another via a data bus 75. The CPU 71, the ROM 72, and the RAM 73 configure a control unit 700. That is, the CPU 71 operates according to a control program stored in the ROM 72 or the memory unit 74 and loaded in the RAM 73, whereby the control unit 700 executes control processing for the checkout machine 7 explained below.

The RAM 73 includes a commodity information section 731 and a transaction information section 732. The commodity information section 731 stores commodity information (including an individual commodity code) of a commodity subjected to commodity registration processing. The transaction information section 732 stores commodity information (including an individual commodity code) and settlement information of a commodity subjected to settlement processing.

The memory unit 74 is configured by a nonvolatile memory such as a HDD or a flash memory in which stored information is retained even if power is turned off. The memory unit 74 includes a control program section 741 that stores the control program, a commodity master 742, and a fitting room number section 743. The commodity master 742 stores commodity information of commodities sold in the store M. The fitting room number section 743 stores a fitting room number of the fitting room E in which the checkout machine 7 is installed.

The control unit 700 is connected to an operation unit 77, the display unit 78, the antenna 79, a reader writer 80, and a printer 81 via the data bus 75 and a controller 76. The operation unit 77 is a keyboard operated by a customer who entered the fitting room E and is, for example, a touch panel provided on the display unit 78. The operation unit 77 includes a start key 771 and a settlement key 772. The start key 771 is operated if commodity registration for a commodity to be purchased among commodities brought into the fitting room E is started. If the start key 771 is operated, the control unit 700 is capable of starting the commodity registration processing for the commodity to be purchased. The settlement key 772 is operated if settlement processing is performed for a commodity subjected to the commodity registration processing. If the settlement key 772 is operated, the control unit 100 performs settlement processing for the commodity subjected to the commodity registration processing.

The display unit 78 displays information to a customer who performs commodity registration operation and settlement operation. The antenna 79 receives tag information of a wireless tag attached to a commodity for which the commodity registration operation was performed. The checkout machine 7 receives, for example, using a publicly-known near field wireless communication technology (NFC), the tag information from the wireless tag brought close to the antenna 79 up to a predetermined distance (for example, several centimeters). That is, the antenna 79 receives the tag information from the wireless tag attached to the commodity for which the commodity registration operation for bringing the commodity close to the antenna 79 was performed and does not receive tag information of a wireless tag attached to a commodity for which the commodity registration operation is not performed even if the commodity is present in the fitting room E.

The reader writer 80 acquires, from a medium (for example, a credit card or a portable terminal for performing code settlement) used for settlement processing, information (for example, customer information and a medium number for specifying the medium) for performing the settlement processing. The printer 81 dispenses a receipt on which commodity information and settlement information relating to purchase commodities subjected to the settlement processing are printed.

The control unit 700 is connected to a communication unit 82 via the data bus 75. The communication unit 82 is connected to the digital mirrors 1, the server 3, the gate 5, and the display 9 via the communication line L to be capable of transmitting and receiving information and data.

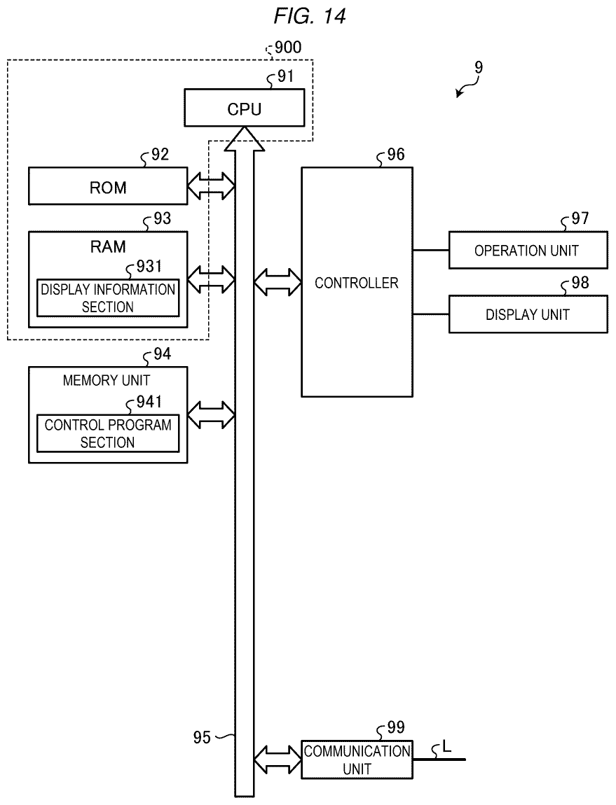

Subsequently, hardware of the display 9 is explained. FIG. 14 is a block diagram illustrating hardware components of the display 9. As illustrated in FIG. 14, the display 9 includes a CPU 91 that is an example of a processor, a ROM 92, a RAM 93, and a memory unit 94. The CPU 91 serves as a control entity. The ROM 92 stores various programs. Various data are loaded in the RAM 93. The memory unit 94 stores various programs. The CPU 91, the ROM 92, the RAM 93, and the memory unit 94 are connected to one another via a data bus 95. The CPU 91, the ROM 92, and the RAM 93 configure a control unit 900. That is, the CPU 91 operates according to a control program stored in the ROM 92 or the memory unit 94 and loaded in the RAM 93, whereby the control unit 900 executes control processing for the display 9 explained below.

The RAM 93 includes a display information section 931. The display information section 931 stores display information including purchase commodity information indicating purchase commodities to be purchased and nonpurchase commodity information indicating nonpurchase commodities not to be purchased, the display information being received from the server 3.

The memory unit 94 is configured by a nonvolatile memory such as a HDD or a flash memory in which stored information is retained even if power is turned off. The memory unit 94 includes a control program section 941 that stores the control program.

The control unit 900 is connected to an operation unit 97 and a display unit 98 via the data bus 95 and a controller 96. The operation unit 97 is a keyboard operated by an operator (a store clerk) who operates the display 9 and is, for example, a touch panel provided on the display unit 98. The display unit 98 displays information (for example, display information) to the store clerk who operates the display 9.

The control unit 900 is connected to a communication unit 99 via the data bus 95. The communication unit 99 is connected to the digital mirrors 1, the server 3, the gate 5, and the checkout machines 7 via the communication line L to be capable of transmitting and receiving information and data.

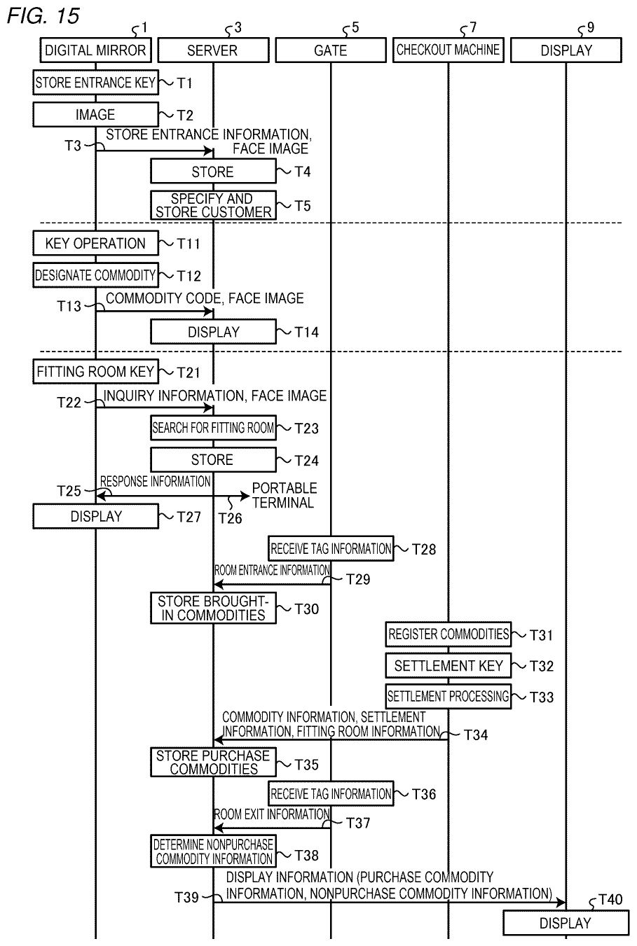

A flow of main processing among the devices of the system 90 is explained below. FIG. 15 is a sequence chart illustrating a flow of main processing among the digital mirror 1, the server 3, the gate 5, the checkout machine 7, and the display 9 configuring the system 90. As illustrated in FIG. 15, if a customer enters the store M, the store entrance key 171 displayed on the digital mirror 1 is operated (T1). Then, the digital mirror 1 actuates the camera 19 and images the face of the customer who entered the store M (T2). The digital mirror 1 transmits a captured face image and store entrance information to the server 3 (T3). The server 3 stores the received face image and the received store entrance information (T4). Then, the server 3 compares a feature value calculated based on the stored face image and feature values stored in the customer master 342 (the face feature section 3423), specifies a customer for whom a feature value having the highest similarity is stored, and creates and stores the customer file 332 relating to the customer (T5).

If the commodity key 173 or the history browsing key 174 displayed on the digital mirror 1 is operated (T11), the digital mirror 1 receives commodities corresponding to the commodity key 173 or the history browsing key 174 from the server 3 and displays the commodities. The customer designates (selects) one or a plurality of commodities out of the displayed commodities (T12). The digital mirror 1 transmits a commodity code (commodity codes) for specifying a type (types) of the designated commodity (commodities) and the face image captured by the camera 19 to the server 3 (T13). The server 3, which received the commodity code (s) and the face image, specifies the customer from the face image and displays, on a display unit (not illustrated), information concerning the commodity (commodities) designated by the customer. A store clerk takes the designated commodity (commodities) from the shelves D and delivers the commodity (commodities) to the customer.

If the fitting room key 172 displayed on the digital mirror 1 is operated (T21), the digital mirror 1 transmits the face image captured by the camera 19 and inquires the server 3 about a vacant fitting room E (T22). The server 3 searches through the fitting room information section 333 and extracts a vacant fitting room E (T23). The server 3 specifies the customer based on the received face image and stores a fitting room number of the extracted fitting room E in the fitting room section 3324 of the already created customer file 332 of the customer (T24). Then, the server 3 transmits fitting room information indicating the stored fitting room number to the digital mirror 1 that made the inquiry (T25) and, at the same time, transmits the fitting room information to the portable terminal 4 of the customer as well (T26). The digital mirror 1, which received the fitting room information, displays, on the display unit 18, the fitting room number included in the received fitting room information (T27). The portable terminal 4, which received the fitting room information, also displays the fitting room number.

If the fitting room number is displayed, the customer goes to the fitting area Mc carrying commodities to be tried on and passes through the gate 5. The gate 5 receives tag information transmitted by wireless tags attached to the commodities carried by the passing customer (T28). Since the room entrance and exit sensor 60 detects that the customer enters the fitting room E, the gate 5 transmits, to the server 3, room entrance information including individual commodity codes (that is, brought-in commodity information) of the commodities extracted from the received tag information and information indicating that the customer enters the fitting room E (T29). If receiving the room entrance information, the server 3 stores, in the brought-in commodity section 3325, the brought-in commodity information included in the room entrance information (T30).

The customer, who entered the fitting room E, tries the brought-in commodities on, determines commodities to be purchased, and operates the checkout machine 7 to perform commodity registration operation for the commodities to be purchased. The checkout machine 7 executes commodity registration processing for the commodities for which the commodity registration operation was performed (T31). If performing the commodity registration processing, the checkout machine 7 writes, using the antenna 79, in wireless tags attached to the commodities, checkout finish information indicating that the commodity registration processing was performed (settlement processing was substantially performed) If the settlement key 772 is operated (T32), the checkout machine 7 executes settlement processing for the commodities subjected to the commodity registration processing (T33). In the settlement processing, the checkout machine 7 dispenses, from the printer 81, a receipt on which commodity information and settlement information relating to the commodities subjected to the settlement processing are printed.

The checkout machine 7 transmits the commodity information (including individual commodity codes) and the settlement information of the commodities subjected to the settlement processing and the fitting room information stored in the fitting room number section 743 to the server 3 (T34). The server 3 stores, based on the received commodity information, the received settlement information, and the received fitting room information, purchase commodity information (individual commodity codes of the purchased commodities) in the settled commodity section 3326 of the customer in which the fitting room information is stored (T35).

The customer, who finished the try-on and the settlement of the commodities to be purchased, exits the fitting room E carrying the brought-in commodities (brings out the brought-in commodities from the fitting room E) and passes through the gate 5. The gate 5 receives tag information from the passing brought-in commodities (T36). In order to detect the room exit of the customer with the room entrance and exit sensor 60, the gate 5 transmits, to the server 3, room exit information including the individual commodity codes of the commodities included in the received tag information and information indicating that the room exit was detected (T37). The server 3 searches through the brought-in commodity section 3325 based on the individual commodity codes included in the received room exit information and determines, based on brought-in commodity information (information stored in the brought-in commodity section 3325) of the customer in which the same individual commodity codes are stored and the purchase commodity information subjected to the commodity registration processing (information stored in the settled commodity section 3326), nonpurchase commodities not to be purchased (T38). Then, the server 3 transmits, to the display 9, display information for causing the display 9 to display the purchase commodities and the nonpurchase commodities to be distinguished, the display information including the purchase commodity information and nonpurchase commodity information for specifying the nonpurchase commodities (T39). The display 9 displays, based on the received display information, the purchase commodities and the nonpurchase commodities to be distinguished such that the nonpurchase commodities can be recognized (T40).

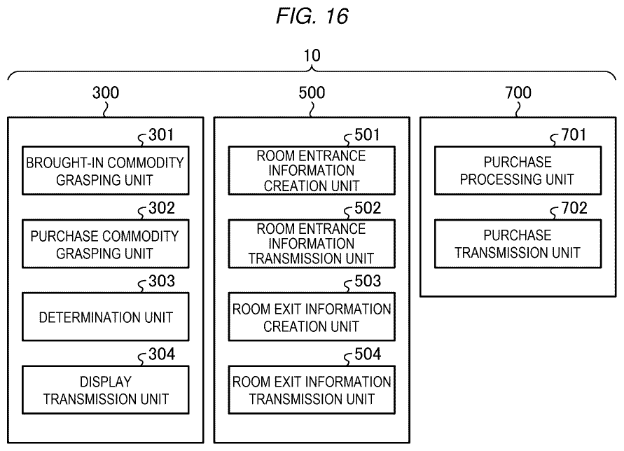

Functional components of the server 3, the gate 5, and the checkout machine 7 (that is, the information processing system 10) are explained below. FIG. 16 is a functional block diagram illustrating the functional components of the server 3, the gate 5, and the checkout machine 7.

The control unit 300 of the server 3 follows the control program stored in the ROM 32 or the control program section 341 of the memory unit 34 to function as a brought-in commodity grasping unit 301, a purchase commodity grasping unit 302, a determination unit 303, and a display transmission unit 304.

The brought-in commodity grasping unit 301 grasps, based on individual commodity codes of brought-in commodities brought into the fitting room E, the brought-in commodities. Specifically, the brought-in commodity grasping unit 301 stores, based on room entrance information received from the gate 5, brought-in commodity information (individual commodity codes) included in the room entrance information in the brought-in commodity section 3325.

The purchase commodity grasping unit 302 grasps, based on individual commodity codes of, among the grasped brought-in commodities, purchase commodities subjected to commodity purchasing processing in the checkout machine 7 installed in the fitting room E, the purchase commodities. Specifically, the purchase commodity grasping unit 302 stores, in the settled commodity section 3326, the individual commodity codes of the purchase commodities subjected to the commodity purchase processing in the checkout machine 7.

As an example, the purchase commodity grasping unit 302 stores, in the settled commodity section 3326, individual commodity codes of commodities subjected to commodity registration processing in the checkout machine 7. As an example, the purchase commodity grasping unit 302 stores, in the settled commodity section 3326, individual commodity codes of commodities subjected to commodity registration processing and settlement processing in the checkout machine 7.

The determination unit 303 determines, from the brought-in commodities and the purchase commodities, nonpurchase commodities not to be purchased. Specifically, the determination unit 303 determines the nonpurchase commodities based on the brought-in commodity information of the commodities brought into the fitting room E by the customer and purchase commodity information of the commodities subjected to the settlement processing (that is, commodity registration processing). More specifically, the determination unit 303 determines the nonpurchase commodities based on the brought-in commodity information stored in the brought-in commodity section 3325 and the purchase commodity information stored in the settled commodity section 3326. The determination unit 303 determines that commodities other than the commodities specified by the purchase commodity information stored in the settled commodity section 3326 (commodities not subjected to the commodity registration processing) in the brought-in commodity information stored in the brought-in commodity section 3325 are the nonpurchase commodities.

The display transmission unit 304 transmits, to the display 9 provided near the fitting room E, display information for causing the display 9 to display the purchase commodities and the nonpurchase commodities to be discriminable. Specifically, the display transmission unit 304 transmits, to the display 9, display information for causing the display 9 to distinguish and display the purchase commodities specified by the purchase commodity information and the nonpurchase commodities specified by the nonpurchase commodity information.

The control unit 500 of the gate 5 follows the control program stored in the ROM 52 or the control program section 541 of the memory unit 54 to function as a room entrance information creation unit 501, a room entrance information transmission unit 502, a room exit information creation unit 503, and a room exit information transmission unit 504.

The room entrance information creation unit 501 creates, based on tag information indicating brought-in commodities brought into the fitting room E, the tag information being transmitted from wireless tags attached to the brought-in commodities and being received by the antenna 59 of the gate 5, brought-in commodity information (including individual commodity codes) indicating the brought-in commodities brought into the fitting room E. Specifically, the room exit information creation unit 503 creates, based on the tag information received by the antenna 59 of the gate 5, room entrance information including brought-in commodity information (individual commodity codes) of the commodities brought into the fitting room E by the customer and information indicating that the customer entered the fitting room E.

The room entrance information transmission unit 502 transmits, to the server 3, the brought-in commodity information indicating the brought-in commodities brought into the fitting room E, the brought-in commodity information being based on the tag information indicating the brought-in commodities brought into the fitting room E, the tag information being transmitted from the wireless tags attached to the brought-in commodities and being received by the antenna 59 of the gate 5. Specifically, the room entrance information transmission unit 502 sends entrance information (including individual commodity codes) created by the room entrance information creation unit 501 to the server 3.

The room exit information creation unit 503 creates, based on the tag information received by the gate 5, room exit information including brought-out commodity information of commodities brought out from the fitting room E by the customer and information indicating that the customer exited the fitting room E.

The room exit information transmission unit 504 transmits the room exit information created by the room exit information creation unit 503 to the server 3.

The control unit 700 of the checkout machine 7 follows the control program stored in the ROM 72 or the control program section 741 of the memory unit 74 to function as a purchase processing unit 701 and a purchase transmission unit 702.

The purchase processing unit 701 performs purchase processing for purchase commodities among brought-in commodities brought into the fitting room E. The purchase processing unit 701 executes commodity registration processing for purchase commodities among commodities brought into the fitting room E. The purchase processing unit 701 executes commodity registration processing and settlement processing for commodities to be purchased among the commodities brought into the fitting room E.

The purchase transmission unit 702 transmits purchase commodity information of commodities subjected to purchase processing to the server 3. Specifically, the purchase transmission unit 702 transmits purchase commodity information (including individual commodity codes) of commodities subjected to commodity registration processing to the server 3. More specifically, the purchase transmission unit 702 transmits purchase commodity information of commodities subjected to commodity registration processing and settlement processing to the server 3.

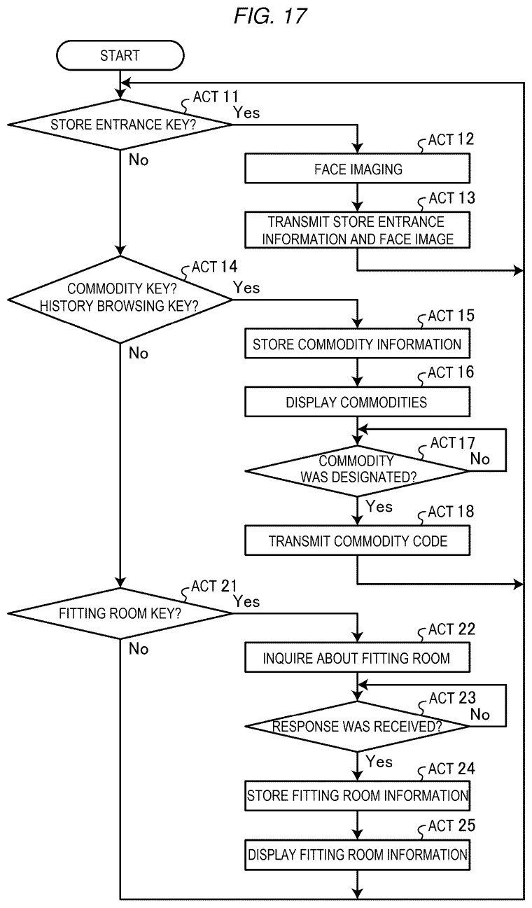

Control for the digital mirror 1 is explained below. FIG. 17 is a flowchart illustrating control processing for the digital mirror 1. The control unit 100 of the digital mirror 1 determines whether the store entrance key 171 was operated (ACT 11). If determining that that store entrance key 171 was operated (Yes in ACT 11), the control unit 100 images, using the camera 19, the face of a customer who operated the store entrance key 171 located in the front of the digital mirror 1 (ACT 12). The control unit 100 stores a captured face image in the image storage section 131. Subsequently, the control unit 100 transmits, to the server 3, information concerning the face image stored in the image storage section 131 and store entrance information indicating that the customer entered the store (ACT 13). Then, the control unit 100 returns to ACT 11.

If determining that the store entrance key 171 was not operated (No in ACT 11), the control unit 100 determines whether the commodity key 173 or the history browsing key 174 was operated (ACT 14). If determining that the commodity key 173 or the history browsing key 174 was operated (Yes in ACT 14), the control unit 100 receives, from the server 3, information concerning commodities extracted by search and stores the information in the commodity information section 132 (ACT 15). The control unit 100 displays, on the display unit 18, the stored commodity information of the commodities to be selectable (ACT 16). Subsequently, the control unit 100 determines whether a desired commodity was designated by a customer from the displayed commodities (ACT 17). The control unit 100 stays on standby until a commodity is designated (No in ACT 17) If a desired commodity is designated (Yes in ACT 17), the control unit 100 transmits, to the server 3, a commodity code for specifying the designated commodity and a face image captured by the camera 19 (ACT 18). Then, the control unit 100 returns to ACT 11.

If determining that the commodity key 173 and the history browsing key 174 were not operated (No in ACT 14), the control unit 100 determines whether the fitting room key 172 was operated (ACT 21). If determining that the fitting room key 172 was operated (Yes in ACT 21), the control unit 100 inquires the server 3 about a vacant fitting room E (ACT 22). The control unit 100 determines whether a response was received from the server 3 (ACT 23). The control unit 100 stays on standby until a response is received (No in ACT 23). If determining that a response was received (Yes in ACT 23), the control unit 100 stores, in the fitting room number section 133, fitting room information indicating a fitting room number of a vacant fitting room E for which the response was received (ACT 24). The control unit 100 displays the stored fitting room number on the display unit 18 (ACT 25). Then, the control unit 100 returns to ACT 11. If determining that the fitting room key 172 was not operated (No in ACT 21), the control unit 100 returns to ACT 11.

The digital mirror 1 in the embodiment explained above is a looking glass usually used by a customer. If a customer who extracted commodities from the commodity display area Mb operates the fitting room key 172 to use the fitting room E, the digital mirror 1 can display a fitting room number of a vacant fitting room E.

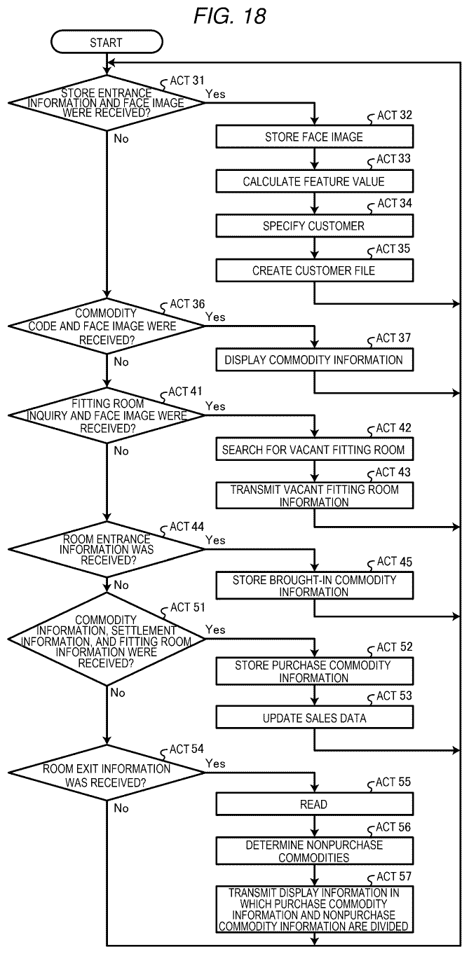

Control for the server 3 is explained below. FIG. 18 is a flowchart illustrating control processing for the server 3. As illustrated in FIG. 18, the control unit 300 of the server 3 determines whether store entrance information and a face image were received from the digital mirror 1 (ACT 31). If determining that store entrance information and a face image were received (Yes in ACT 31), the control unit 300 stores the received face image in the face image storage section 331 (ACT 32). The control unit 300 calculates, using the general object recognition technology, a feature value of the face based on the stored face image (ACT 33). The control unit 300 compares the calculated feature value and the feature values stored in the face feature section 3423 and specifies a customer ID (that is, specifies a customer) stored in the customer ID section 3421 that stores a feature value having the highest similarity (ACT 34). The control unit 300 creates the customer file 332 for a customer having the customer ID (ACT 35). That is, the control unit 300 reads, from the face feature section 3423, a feature value stored to correspond to the specified customer ID and stores the feature value in the face feature section 3322 and reads customer information from the customer information section 3422 and stores the customer information in the customer information section 3323. The control unit 300 creates the fitting room section 3324, the brought-in commodity section 3325, and the settled commodity section 3326 to correspond to the customer ID. Then, the control unit 300 returns to ACT 31.

If determining that store entrance information and a face image were not received (No in ACT 31), the control unit 300 determines whether the commodity key 173 or the history browsing key 174 was operated and a commodity code of a commodity extracted by a customer and a face image captured by the camera 19 were received from the digital mirror 1 (ACT 36). If determining that the commodity code and the face image were received (Yes in ACT 36), the control unit 300 displays information concerning a commodity specified by the received commodity code on a display unit (not illustrated) that a store clerk views (ACT 37). Then, the control unit 300 returns to ACT 31. The store clerk delivers the displayed commodity to the customer.

If determining that the commodity code and the face image were not received (No in ACT 36), the control unit 300 determines whether an inquiry about the fitting room E and a face image were received (ACT 41). If determining that an inquiry about the fitting room E and a face image were received (Yes in ACT 41), the control unit 300 searches for a vacant fitting room E based on the vacancy information stored in the fitting room information section 333 (specifically, the flag information stored in the use information section 3332) (ACT 42). The control unit 300 extracts a vacant fitting room E. The control unit 300 transmits fitting room information indicating a fitting room number of the extracted fitting room E to the digital mirror 1 (ACT 43). Then, the control unit 300 returns to ACT 31.

If determining that an inquiry about the fitting room E and a face image were not received (No in ACT 41), the control unit 300 determines whether room entrance information was received from the gate 5 (ACT 44). If it is determined that room entrance information was received (Yes in ACT 44), the brought-in commodity grasping unit 301 stores brought-in commodity information included in the room entrance information in the brought-in commodity section 3325 (ACT 45) Then, the control unit 300 returns to ACT 31.

If determining that room entrance information was not received (No in ACT 44), the control unit 300 determines whether commodity information, settlement information, and fitting room information were received from the checkout machine 7 (ACT 51). If it is determined that commodity information, settlement information, and fitting room information were received (Yes in ACT 51), the purchase commodity grasping unit 302 stores purchase commodity information in the settled commodity section 3326 in association with a customer ID for which the received fitting room information is stored (ACT 52). The control unit 300 updates, based on the received commodity information and the received settlement information, the sales data stored in the sales management section 334 (ACT 53). Then, the control unit 300 returns to ACT 31.

If determining that commodity information, settlement information, and fitting room information were not received (No in ACT 51), the control unit 300 determines whether room exit information was received from the gate 5 (ACT 54). If determining that room exit information was received (Yes in ACT 54), the control unit 300 searches through the brought-in commodity section 3325 based on an individual commodity code included in the room exit information, specifies a customer ID for which the same individual commodity code is stored, and reads brought-in commodity information stored in the brought-in commodity section 3325 and purchase commodity information stored in the settled commodity section 3326 (ACT 55). The determination unit 303 determines, based on the read brought-in commodity information and the read purchase commodity information, nonpurchase commodity information relating to nonpurchase commodities (ACT 56). The display transmission unit 304 transmits, to the display 9, display information (the purchase commodity information, the nonpurchase commodity information, the customer ID, and the fitting room information of the customer) with which purchase commodities and nonpurchase commodities can be divided and displayed to be discriminative (ACT 57). Then, the control unit 300 returns to ACT 31. If determining that room exit information was not received (No in ACT 54), the control unit 300 returns to ACT 31.

The server 3 in the embodiment explained above is capable of determining, based on brought-in commodity information of brought-in commodities brought into the fitting room E and purchase commodity information of purchased purchase commodities, nonpurchase commodities brought into the fitting room E but not purchased and causing the display 9 to divide and display information concerning the purchase commodities and the nonpurchase commodities. The store clerk can easily collect the nonpurchase commodities according to the information concerning the purchase commodities and the nonpurchase commodities displayed on the display 9.

Since the server 3 in the embodiment causes the display 9 to divide and display the information concerning the purchase commodities and the nonpurchase commodities, the store clerk can correctly collect the nonpurchase commodities. For that reason, the customer returns, to an appropriate shelf D, nonpurchase commodities that the store clerk forgot to collect, whereby a burden of the store clerk moving the commodities to correct positions is reduced. Therefore, it is possible to reduce influence on a security system (for example, a patrol) in the store M tackled by the store clerk.

The server 3 in the embodiment creates the customer file 332 of a customer who entered the store M and stores fitting room information of the fitting room E used by the customer in the fitting room section 3324. Therefore, if the customer left a thing in the fitting room E, it is possible to easily specify the customer.

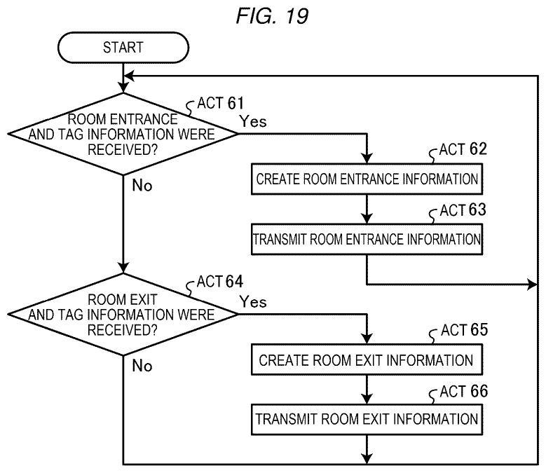

Control for the gate 5 is explained below. FIG. 19 is a flowchart illustrating control processing for the gate 5. As illustrated in FIG. 19, the control unit 500 of the gate 5 determines whether information concerning room entrance of a customer detected by the room entrance and exit sensor 60 and tag information were received (ACT 61). If determining that information concerning room entrance and tag information were received (Yes in ACT 61), the control unit 500 stores the received tag information in the tag information section 531. The control unit 500 stores an individual commodity code extracted from the stored tag information in the brought-in commodity information section 532. The room entrance information creation unit 501 creates room entrance information including the stored individual commodity code and the information concerning the room entrance (ACT 62). The room entrance information transmission unit 502 transmits the created room entrance information to the server 3 (ACT 63). Then, the control unit 500 returns to ACT 61.

If determining that information concerning room entrance and tag information were not received (No in ACT 61), the control unit 500 determines whether information concerning room exit of a customer detected by the room entrance and exit sensor 60 and tag information were received (ACT 64). If determining that information concerning room exit and tag information were received (Yes in ACT 64), the control unit 500 stores the received tag information in the tag information section 531. The control unit 500 stores an individual commodity code extracted from the stored tag information in the brought-in commodity information section 532. The room exit information creation unit 503 creates room exit information including the stored individual commodity code and the information concerning the room exit (ACT 65). The room exit information transmission unit 504 transmits the created room exit information to the server 3 (ACT 66). Then, the control unit 500 returns to ACT 61.

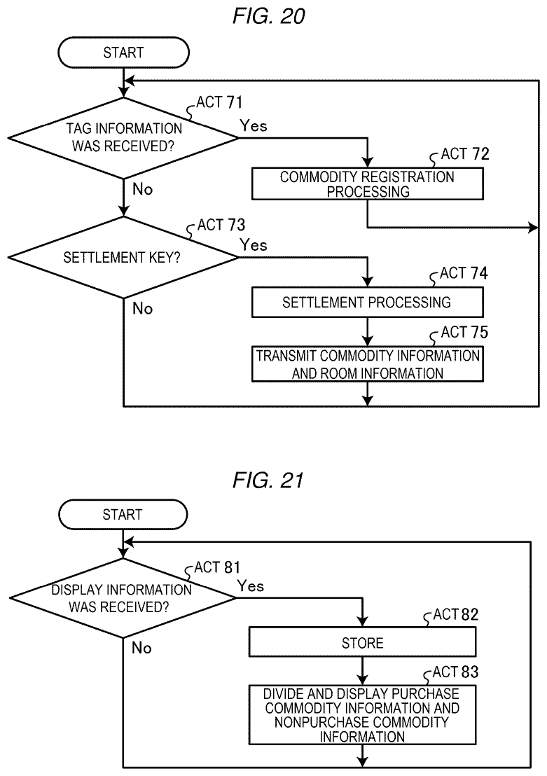

Control for the checkout machine 7 is explained below. FIG. 20 is a flowchart illustrating control processing for the checkout machine 7. If the start key 771 is operated, the processing of the flowchart illustrated in FIG. 20 is enabled. A customer performs commodity registration operation for bringing a wireless tag attached to a commodity to be purchased close to the antenna 79. The control unit 700 determines whether the antenna 79 received tag information (ACT 71). If it is determined that tag information was received (Yes in ACT 71), the purchase processing unit 701 extracts an individual commodity code of a commodity from the received tag information and executes commodity registration processing relating to the commodity based on the individual commodity code (ACT 72). In the commodity registration processing (the wireless tag is still located near the antenna 79), the control unit 700 writes, using the antenna 79, in the wireless tag, the tag information of which was received in ACT 71, settlement finish information indicating that the commodity registration processing is finished (that is, settlement processing is finished). Then, the control unit 700 returns to ACT 71.

If determining that tag information was not received (No in ACT 71), the control unit 700 determines whether the settlement key 772 was operated (ACT 73). If it is determined that the settlement key 772 was operated (Yes in ACT 73), the purchase processing unit 701 executes, based on the commodity information stored in the commodity information section 731, settlement processing for a purchase commodity to be purchased (ACT 74). The control unit 700 stores, in the transaction information section 732, commodity information and settlement information of the commodity subjected to the settlement processing. The purchase transmission unit 702 transmits, to the server 3, the commodity information and the settlement information stored in the transaction information section 732 and fitting room information indicating a fitting room number of the fitting room E stored in the fitting room number section 743 (ACT 75). Then, the control unit 700 returns to ACT 71.

Control for the display 9 is explained below. FIG. 21 is a flowchart illustrating control processing for the display 9. As illustrated in FIG. 21, the control unit 900 of the display 9 determines whether display information (purchase commodity information, nonpurchase commodity information, a customer ID, and fitting room information of the customer) was received from the server 3 (ACT 81). If determining that display information was received (Yes in ACT 81), the control unit 900 stores the received display information in the display information section 931 (ACT 82). The control unit 900 divides purchase commodity information and nonpurchase information included in the received display information and displays the purchase commodity information and the nonpurchase commodity information on the display unit 98 (ACT 83). Then, the control unit 900 returns to ACT 81.

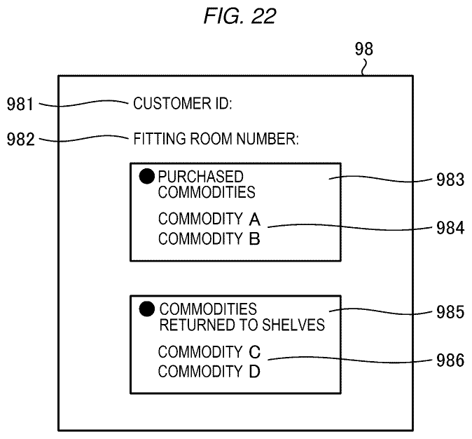

Here, a display example displayed in ACT 83 by the control unit 900 is explained. FIG. 22 is a diagram illustrating a display example on the display unit 98 of the display 9. As illustrated in FIG. 22, on the display unit 98, a customer ID 981 of a customer to be displayed and a fitting room number 982 of a fitting room used by the customer are displayed and an area 983 for displaying purchased commodities (purchase commodities) and an area 984 for displaying commodities not to be purchased (nonpurchase commodities) are surrounded by divided squire frames and displayed. In the area 983, names 9831 of the purchased commodities (in the embodiment, a commodity A and a commodity B) are displayed. In the area 984, names 9841 of the nonpurchase commodities (in the embodiment, a commodity C and a commodity D is displayed. A store clerk viewing the display collects the nonpurchase commodities displayed in the area 984 among brought-in commodities brought out from the fitting room E by the customer and puts the nonpurchase commodities in the collection box B.

As explained above, the display 9 divides the commodities to be collected (the nonpurchase commodities) from the purchase commodities and displays the commodities to be collected. Therefore, a store clerk can easily collect the commodities to be collected.

As explained above, the server 3 in the embodiment includes the brought-in commodity grasping unit 301 that grasps, based on individual commodity codes of brought-in commodities brought into the fitting room E, the brought-in commodities, the purchase commodity grasping unit 302 that grasps, based on commodity specifying information of purchase commodities subjected to commodity registration processing and settlement processing for purchasing a commodity in the checkout machine 7 installed in the fitting room E, the purchase commodities, the determination unit 303 that determines, from the brought-in commodities and the purchase commodities, nonpurchase commodities not to be purchased, and the display transmission unit 304 that transmits, to the display 9 provided near the fitting room E, display information for causing the display 9 to display the purchase commodities and the nonpurchase commodities to be discriminative.

With the server 3 in the embodiment explained above, it is possible to determine, based on information concerning brought-in commodities brought into the fitting room E and information concerning purchased purchase commodities, not-purchased nonpurchase commodities brought into the fitting room E and cause the display 9 to divide and display the information concerning the purchase commodities and the nonpurchase commodities to be discriminative.

The embodiment is explained above. However, the embodiment is present as an example and is not intended to limit the scope of the invention. The new embodiment and modifications thereof can be implemented in other various forms. Various omissions, substitutions, and changes can be made without departing from the gist of the invention. The embodiment and the modifications thereof are included in the scope and the gist of the invention and included in the scope of the inventions described in the claims and equivalents of the inventions.

For example, the embodiment is explained using the layout illustrated in FIG. 1. However, not only this, but for example, as illustrated in FIG. 2, if there is one fitting room E, the gate 5 may be provided at the doorway of the fitting room E.

In the embodiment, the server 3 performs, besides the grasping of brought-in commodities, the grasping of purchase commodities, the determination of nonpurchase commodities, and the transmission of display information, the creation of the customer file 332 involved in store entrance registration, the search for a vacant fitting room E, and the search for a commodity. However, another device may perform the creation of the customer file 332, the search for the fitting room E, and the search for a commodity. The creation of the customer file 332, the search for the fitting room E, and the search for a commodity are not essential components of the server 3.

In the embodiment, the determination unit 303 determines that commodities not subjected to the commodity registration processing and the settlement processing by the checkout machine 7 are nonpurchase commodities. However, not only this, but the determination unit 303 may determine commodities not subjected to the commodity registration processing by the checkout machine 7 are nonpurchase commodities. That is, the determination unit 303 may determine, for determination about whether commodities are nonpurchase commodities, whether the commodities are subjected to the settlement processing.

What is claimed is:

1. An information processing device, comprising:
a brought-in commodity grasping component configured to grasp, based on commodity specifying information of brought-in commodities brought into a fitting room, the brought-in commodities;
a purchase commodity grasping component configured to grasp, based on commodity specifying information of, among the brought-in commodities, purchase commodities subjected to commodity purchasing processing in a purchase processing device installed in the fitting room, the purchase commodities;
a determination component configured to determine, from the brought-in commodities and the purchase commodities, nonpurchase commodities not to be purchased; and
a display transmission component configured to transmit, to a display provided near the fitting room, display information for causing the display to display the purchase commodities and the nonpurchase commodities so as to be discriminable.

2. The information processing device according to claim 1, wherein
the purchase commodity grasping component grasps the purchase commodities subjected to commodity registration processing for purchasing commodities in the purchase processing device, and
the determination component determines that commodities not subjected to the commodity registration processing are the nonpurchase commodities.

3. The information processing device according to claim 1, wherein
the purchase commodity grasping component grasps the purchase commodities subjected to commodity registration processing and settlement processing for purchasing commodities in the purchase processing device, and
the determination component determines that commodities not subjected to the commodity registration processing and the settlement processing are the nonpurchase commodities.

4. The information processing device according to claim 1, wherein the determination component performs the determination on condition that a customer exited the fitting room.

5. The information processing device according to claim 1, wherein the display is a personal computer, a tablet terminal, a portable terminal, or a wearable terminal.

6. The information processing device according to claim 1, wherein the purchase commodity grasping component stores, in a settled commodity section, individual commodity codes of commodities subjected to commodity registration processing in a checkout machine.

7. An information processing method, comprising:
grasping, based on commodity specifying information of brought-in commodities brought into a fitting room, the brought-in commodities;
grasping, based on commodity specifying information of, among the brought-in commodities, purchase commodities subjected to commodity purchasing processing in a purchase processing device installed in the fitting room, the purchase commodities;
determining, from the brought-in commodities and the purchase commodities, nonpurchase commodities not to be purchased; and
transmitting, to a display provided near the fitting room, display information for causing the display to display the purchase commodities and the nonpurchase commodities so as to be discriminable.

8. The information processing method according to claim 7, further comprising:
grasping the purchase commodities subjected to commodity registration processing for purchasing commodities in the purchase processing device, and
determining that commodities not subjected to the commodity registration processing are the nonpurchase commodities.

9. The information processing method according to claim 7, further comprising:
grasping the purchase commodities subjected to commodity registration processing and settlement processing for purchasing commodities in the purchase processing device, and
determining that commodities not subjected to the commodity registration processing and the settlement processing are the nonpurchase commodities.

10. The information processing method according to claim 7, further comprising:
performing the determining on condition that a customer exited the fitting room.

11. The information processing method according to claim 7, wherein the display is a personal computer, a tablet terminal, a portable terminal, or a wearable terminal.

12. The information processing method according to claim 7, further comprising:
storing, in a settled commodity section, individual commodity codes of commodities subjected to commodity registration processing in a checkout machine.

13. An information processing system, comprising:
a gate provided near an entrance of a fitting room;
a purchase processing device provided in the fitting room; and
an information processing device, wherein
the gate includes:
an antenna; and
a room entrance information transmission component configured to transmit, to the information processing device, brought-in commodity information indicating brought-in commodities brought into the fitting room, the brought-in commodity information being based on wireless tag information indicating a commodity, the wireless tag information being transmitted from a wireless tag attached to the commodity and being received by the antenna,
the purchase processing device includes:
a purchase processing component configured to perform purchase processing for a singularity of or a plurality of the brought-in commodities; and
a purchase transmission component configured to transmit purchase commodity information of purchase commodities subjected to purchase processing to the information processing device, and
the information processing device includes:
a brought-in commodity grasping component configured to store the brought-in commodity information received from the gate;
a purchase commodity grasping component configured to store the purchase commodity information received from the purchase processing device;
a determination component configured to determine, from the brought-in commodity information and the purchase commodity information, nonpurchase commodities not to be purchased; and
a display transmission component configured to transmit, to a display unit provided adjacent to the fitting room, display information for causing the display unit to display the purchase commodities and the nonpurchase commodities so as to be discriminable.

14. The information processing system according to claim 13, wherein the gate acquires individual commodity codes included in a received tag information and transmits room entrance information including the individual commodity codes to a server.

15. The information processing system according to claim 13, wherein
the purchase commodity grasping component grasps the purchase commodities subjected to commodity registration processing for purchasing commodities in the purchase processing device, and
the determination component determines that commodities not subjected to the commodity registration processing are the nonpurchase commodities.

16. The information processing system according to claim 13, wherein
the purchase commodity grasping component grasps the purchase commodities subjected to commodity registration processing and settlement processing for purchasing commodities in the purchase processing device, and
the determination component determines that commodities not subjected to the commodity registration processing and the settlement processing are the nonpurchase commodities.

17. The information processing system according to claim 13, wherein the determination component performs the determination on condition that a customer exited the fitting room.

18. The information processing system according to claim 13, wherein the display is a personal computer, a tablet terminal, a portable terminal, or a wearable terminal.

19. The information processing system according to claim 13, wherein the purchase commodity grasping component stores, in a settled commodity section, individual commodity codes of commodities subjected to commodity registration processing in a checkout machine.
